(19) United States
(12) Patent Application Publication
(10) Pub. No.: US 2005/0040105 A1
(43) Pub. Date: Feb. 24, 2005

(54) Ammonia nitrification over a carbonate alkalinity source

(76) Inventor: Rodolfo Ernesto Kilian, (US)

Correspondence Address: Dennis W. Beech;LAW OFFICES OF DENNIS W. BEECH, 19900 Beach Blvd., Suite C-2, Huntington Beach, CA, 92648, US

(21) Appl. No.: 10/945,715

(22) Filed: Sep. 20, 2004

Related U.S. Application Data
(63) Continuation-in-part of application No. 10/367,283, filed on Feb. 14, 2003.

(51) Int. Cl. C02F 3/00

(52) U.S. Cl. 210/616

(57) ABSTRACT

The ammonia nitrification over a calcite slurry process and system may be used for treating an ammonia containing fluid. An influent fluid stream may be introduced into an aerobic contact element that may have a microbial population therein. A plurality of calcite particles and oxygen may be introduced into the aerobic contact element. The contents of the aerobic contract element may be mixed. The contents may be communicated to a separation element to output a nitrified fluid stream overflow and for recycled a collected calcite particle stream.

This is a continuation-in-part application of U.S. patent application Ser. No. 10/367,283. U.S. application Ser. No. 10/367,283 is pending.

### BACKGROUND OF THE INVENTION

This invention relates to systems and processes for nitrification of ammonia that may be contained in a fluid in order to convert the ammonia into less toxic nitrates. The new system and method introduces a relatively insoluble source of alkalinity for nitrification to reduce the chance of damaging the microorganisms that may be involved in the conversion process as well as reduce other detrimental effects that may occur due to changes in pH.

Nitrification of ammonia may be necessary in fluid streams associated with anaerobic digestion systems of waste treatment systems to convert the ammonia into less toxic nitrates or nitrites. The waste treatment systems may not have a sufficient source of alkaline material present in influent, as for example wastewater, to provide the alkalinity necessary to nitrify the ammonia. Often treatment systems for ammonia conversion may receive a supplemental outside source of alkaline material. Typically this may be done by adding sodium hydroxide or sodium bicarbonate to a fluid treatment process as for example in a fluid waste recycle stream. However, if such additives are added in excess of requirements for conversion, conditions in a treatment system may become detrimental for the living organisms that exist in and are part of the treatment process. For proper treatment pH level control may be necessary.

### SUMMARY OF THE INVENTION

The present invention is directed to systems and methods for treating an ammonia containing fluid. An influent fluid stream may be introduced into an aerobic contact element that may have a microbial population therein. A slurry of calcite particles and oxygen may be introduced into the aerobic contact element. The contents of the aerobic contact element may be mixed. The contents may be communicated to a separation element to output a nitrified fluid stream overflow and to recycle a collected calcite particle stream.

These and other features, aspects and advantages of the present invention will become better understood with reference to the following drawings, description and claims.

### BRIEF DESCRIPTION OF THE DRAWINGS

FIG. 1 illustrates a functional diagram of an ammonia nitrification process with calcite particles according to an embodiment of the invention;

FIG. 2 illustrates a representation of the layering of material involved in an ammonia nitrification process with calcite particles according to an embodiment of the invention.

### DETAILED DESCRIPTION

The following detailed description represents the best currently contemplated modes for carrying out the invention. The description is not to be taken in a limiting sense, but is made merely for the purpose of illustrating the general principles of the invention.

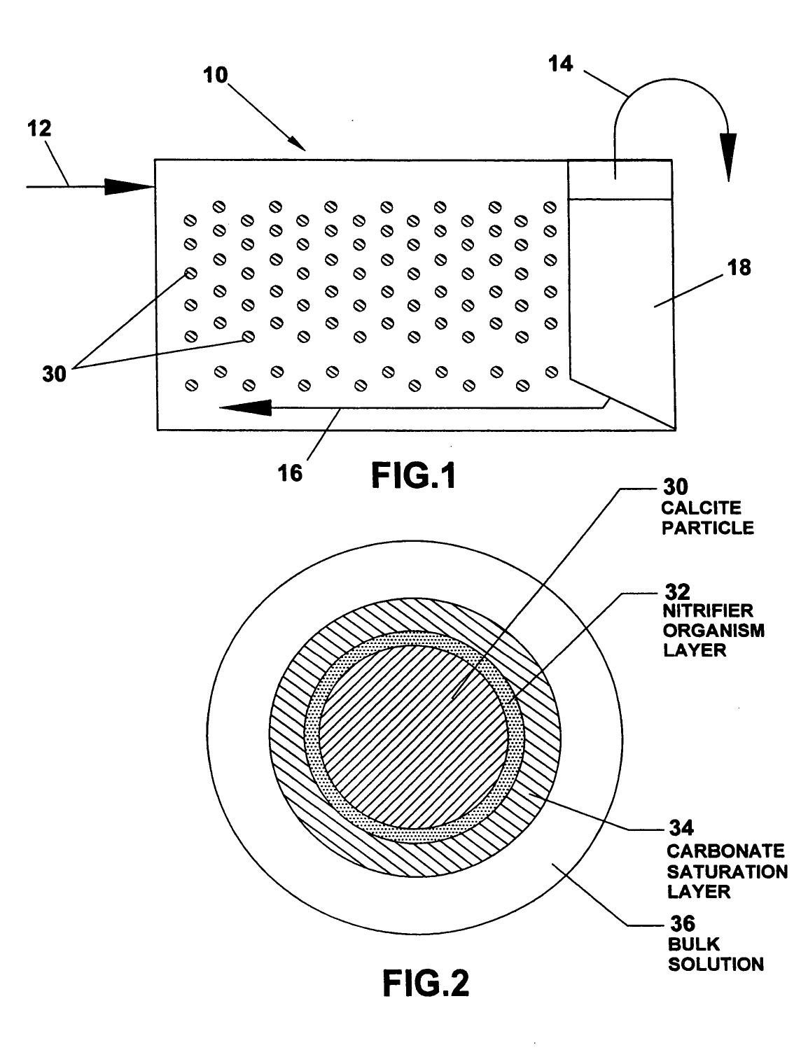

Referring to FIG. 1, a functional diagram of a fluid stream treatment element that may be a reactor 10 that may be a complete mix, a packed bed or a fluidized tower. Calcite particles 30 or powder may be introduced into the reactor 10 and retained for interaction with an ammonia containing fluid stream 12. The reactor 10 may contain the calcite particles 30 suspension and a microbial population for treatment of the fluid stream influent. While calcite particles 30 are used to illustrate an embodiment, other relatively insoluble forms of carbonate alkalinity may be used.

The operating conditions of the reactor 10 may include maintaining the temperature at approximately 5 degrees centigrade to 45 degrees centigrade. The ammonia containing fluid stream 12 that may have ammonium and ammonium ions with a total ammonium concentrate greater than 500 mg/liter may be input into the reactor 10 and mixed with the contents thereof. The reactor 10 may be kept under aerobic conditions with dissolved oxygen. Air or oxygen may be introduced into the reactor 10 or into the fluid stream 12 external to the reactor 10 to maintain a dissolved oxygen residual. An aeration device may be used.

Mixing may be accomplished by use of processed air, agitated air, mechanical mixers or a combination thereof. The reactor 10 may have a retention time of approximately 1 to 24 hours. Discharge from the reactor 10 may be separated by physical or mechanical separation element 18 such that nitrified fluid stream overflow 14 may be removed and collected calcite 30 particles may be recycled 16 to the reactor 10.

Referring to FIG. 2, a representation of the layering of material involved in the process is illustrated. A calcite particle 30 may have a nitrifier organism layer 32 wherein the microorganisms consume the calcite particle 30 over time. The nitrification process may create a carbonate saturation layer 34 intermediate the nitrifier organism layer 32 and the bulk solution 36 in a reactor. The bulk solution 36 may be carbonate limited.

Using a relatively insoluble form of carbonate alkalinity such as the calcite particles 30, limestone, may provide an adequate source of alkalinity that may be available as existing alkalinity is consumed. This may reduce alkaline overdose of microorganisms that may live attached to the calcite particles 30 rather than receiving alkalinity by other methods. Calcite particles 30 may be added to the system to maintain the conversion process.

The calcite particles may provide a large surface area to support the biomass in a reactor that may reduce the size requirements for the system. There may not be a requirement for a complicated pH level control system. The overall reaction of the process may be —NH₄+CaCO₃+O₂ H₂O+CO₂+Ca(NO₃)₂. The nitrification of the ammonia consumes alkalinity because it produces acidity, —NH₄⁺+2O₂ NO⁻+H₂O+2H⁺. The processes may be controlled such that either nitrate or nitrite products may be produced.

While the invention has been particularly shown and described with respect to the illustrated embodiments thereof, it will be understood by those skilled in the art that the foregoing and other changes in form and details may be made therein without departing from the spirit and scope of the invention.

1. A method for treating an ammonia containing fluid, comprising the steps of:
providing an influent fluid stream into an aerobic contact element having a microbial population therein;
introducing a plurality of carbonate alkalinity particles into said aerobic contact element;
introducing oxygen into said aerobic contact element;
mixing the contents of said aerobic contact element; and
communicating the contents of said aerobic contact element to a separation element to output a nitrified fluid stream overflow and to recycle a collected carbonate alkalinity stream for reintroduction into said aerobic contact element.

2. The method as in claim 1 wherein said influent fluid stream comprising ammonium and ammonium ions having a total ammonium concentrate greater than 500 mg/liter.

3. The method as in claim 1 wherein said carbonate alkalinity particles are calcite particles.

4. The method as in claim 1 wherein the operating conditions of said aerobic contact element are a temperature of approximately 5 degrees to 45 degrees centigrade.

5. The method as in claim 1 wherein a retention time for the input fluid stream is approximately 1 hour to 24 hours.

6. A system for treating an ammonia containing fluid comprising:
an aerobic contact element in communication with an influent fluid stream and having a source of microbial matter;
a source of carbonate alkalinity particles in communication with said aerobic contact element;
a source of oxygen in communication with said aerobic contact element;
a mixing device in said aerobic contact element to mix the contents thereof;
a separation element in communication with said aerobic contact element;
an effluent output from said separation element; and
a recycle communication conduit for a collected carbonate alkalinity particle stream for reintroduction into said aerobic contact element.

7. The system as in claim 6 wherein said source of carbonate alkalinity is a plurality of calcite particles.

8. A method for treating an ammonia containing fluid, comprising the steps of:
providing an influent fluid stream having ammonium and ammonium ions with a total ammonium concentration of greater than 500 mg/liter into an anaerobic contact element having a microbial population therein;
introducing a plurality of calcite particles into said aerobic contact element;
introducing oxygen into said aerobic contact element;
mixing the contents of said aerobic contact element;
communicating the contents of said aerobic contact element to a separation element to output a nitrified fluid stream overflow and to recycle a collected carbonate alkalinity stream for reintroduction into said aerobic contact element; and
retaining said input fluid stream for a retention time of approximately 1 hour to 24 hours.
